(19) United States
(12) Patent Application Publication
(10) Pub. No.: US 2023/0309781 A1
(43) Pub. Date: Oct. 5, 2023

(54) Dishwasher with a Cooling Function

(71) Applicant: Sergei Kvitko, Petah-Tikva (IL)

(72) Inventor: Sergei Kvitko, Petah-Tikva (IL)

(21) Appl. No.: 18/041,894

(22) PCT Filed: May 9, 2021
(86) PCT No.: PCT/IL2021/050526

§ 371 Date: Feb. 16, 2023

(30) Foreign Application Priority Data
Sep. 24, 2020 (IL) 277571

(51) Int. Cl. A47L 15/42

(52) U.S. Cl. CPC A47L 15/4276

(57) ABSTRACT

A dishwasher comprising a heat pump that transfers heat from a dishwasher tub to an external environment so that the inside of the dishwasher tub is cooled to a below room temperature, in order to slow down bacterial growth and hinder development of an unpleasant odor inside the dishwasher tub.

### BACKGROUND OF THE INVENTION

Technical Field

The present invention relates to a dishwasher with a cooling function, in which development of an irritating and unpleasant odor from bacterial growth on the dishes kept waiting to be washed is hindered.

Description of the Related Art

A dishwasher is a device for removing food remnants adhered to dishes by forcibly injecting a detergent-diluted washing water to the dishes. When the daily number of dishes put into the dishwasher is small, the users do not start the washing program and choose to wait until the dishwasher is full. An unpleasant odor due to bacterial growth is produced when a pre-wash waiting period of the dishes in the dishwasher is long, and the odor dissipates to the surrounding area in an irritating manner when the closed door of the dishwasher is opened for the purposes of adding in the daily dishes.

Accordingly, there is a need to address the foregoing issues and provide a system and a method for slowing down bacterial growth and thus hindering development of an unpleasant and irritating odor inside a dishwasher.

### SUMMARY OF THE INVENTION

The present invention is designed to solve the problem of the prior art, and therefore an object of the invention is to provide a refrigerating dishwasher that is capable of slowing down bacterial growth and hinder development of bad odor, by cooling the inside of the dishwasher.

The term “refrigerating dishwasher” is synonymous with the term “dishwasher with a cooling function” and these terms could be used interchangeably in the disclosure.

According to a first aspect of the invention there is provided a dishwasher with a cooling function. According to an embodiment of the first aspect of the present invention the dishwasher comprises a heat pump that transfers heat from a dishwasher tub to an external environment so that the inside of the dishwasher tub is cooled to a below room temperature in order to slow down bacterial growth and hinder development of an unpleasant odor inside the dishwasher tub.

According to another embodiment of the first aspect of the present invention, the dishwasher includes a heat pump that comprises a compressor controlled by a refrigeration controller or by a thermostat and connected through a condenser to an expansion valve and to an evaporator, and wherein said evaporator is thermally attached to a dishwasher tub.

According to yet another embodiment of the first aspect of the present invention, the dishwasher further comprises a temperature sensor for measuring temperature inside the dishwasher tub, a display, an on/off switch, wherein said temperature sensor, display and on/off switch are connected to the refrigeration controller.

According to yet another embodiment of the first aspect of the present invention, the dishwasher includes a heat pump based on a thermoelectric cooler thermally attached to a dishwasher tub.

According to a second aspect of the invention there is provided a method of slowing down bacterial growth and as a result slowing down development of an unpleasant odor inside a dishwasher.

According to an embodiment of the second aspect of the invention, the method of slowing down bacterial growth and hindering development of an unpleasant odor inside a dishwasher comprises cooling a dishwasher tub to a below room temperature, wherein said cooling is done by a heat pump that transfers heat from the dishwasher tub to an external environment.

According to another embodiment of the second aspect of the invention, the method of slowing down bacterial growth and hindering development of an unpleasant odor inside a dishwasher comprises cooling the dishwasher tub to a below room temperature, wherein said cooling is done by a heat pump that transfers heat from the dishwasher tub to an external environment, the heat pump is based on a vapor compression cycle, and said cooling may be comprised of refrigeration and defrosting cycles.

The aforementioned summary of preferred and exemplary embodiments of the present invention is merely illustrative of the inventive concepts presented herein and is not intended to limit the scope of the present invention in any manner.

### BRIEF DESCRIPTION OF THE DRAWINGS

The above-mentioned and other features and advantages of the invention, and the manner of attaining them, will become more apparent and the disclosure will be better understood by reference to the following description of embodiments of the invention taken in conjunction with the accompanying drawings, wherein:

FIG. 1 shows a prior art dishwasher;

FIG. 2 shows a schematic drawing of a refrigerating dishwasher according to an embodiment of the invention;

FIG. 3 shows a block diagram of principal electric and electronic components of a refrigerating dishwasher according to an embodiment of the invention;

FIG. 4 shows a perspective view of a refrigerating dishwasher according to an embodiment of the invention.

FIG. 5 shows a schematic drawing of a refrigerating dishwasher according to another embodiment of the invention;

The exemplifications set out herein illustrate preferred embodiments of the invention, and such exemplifications are not to be construed as limiting the scope of the invention in any manner.

### DETAILED DESCRIPTION OF THE PREFERRED EMBODIMENTS

For a better understanding of the invention and to show how the same may be carried into effect, reference will now be made, purely by way of example, to the accompanying drawings. With specific reference to the drawings in detail, it is stressed that the particulars shown are by way of example and for purposes of illustrative discussion of preferred embodiments of the present invention only, and are presented for the purpose of providing what is believed to be the most useful and readily understood description of the principles and conceptual aspects of the invention. In this regard, no attempt is made to show structural details of the invention in more detail than is necessary for a fundamental understanding of the invention. From the description taken together with the drawings it will be apparent to those skilled in the art how the several forms of the invention may be embodied in practice. Moreover, it is to be understood that the phraseology and terminology employed herein is for the purpose of description and should not be regarded as limiting the scope of the invention hereof.

In one aspect, the present invention comprises a dishwasher with a heat pump that transfers heat from the inside of the dishwasher to an external environment so that the inside of the dishwasher is cooled to a below room temperature in order to slow down bacterial growth and hinder development of an irritating and unpleasant smell and odor inside the dishwasher.

Preferably, the below room temperature is a temperature below 40° C. More preferably, the below room temperature is a temperature below 25° C. Even more preferably, the below room temperature is a temperature below 25° C. and above 0° C.

In some embodiments of the invention, the heat pump can be based on a vapor-compression cycle in which circulating working fluid known as refrigerant (for example Freon) enters a compressor as a low pressure and low temperature vapor. The vapor is compressed and exits the compressor superheated. The superheated vapor travels through a water or air-cooled condenser which cools and removes the superheat and condenses the vapor into a liquid. The liquid refrigerant goes through an expansion valve where its pressure abruptly decreases, causing flash evaporation of portion of the liquid. That results in a mixture of liquid and vapor at a lower temperature and pressure. The cold liquid-vapor mixture then travels through an evaporator coil or tubes and is completely vaporized by cooling the warm air (from the space being refrigerated). The resulting refrigerant vapor returns to the compressor inlet to complete the thermodynamic cycle.

In other embodiments of the invention, the heat pump can be based on a thermoelectric cooler such as Peltier plate.

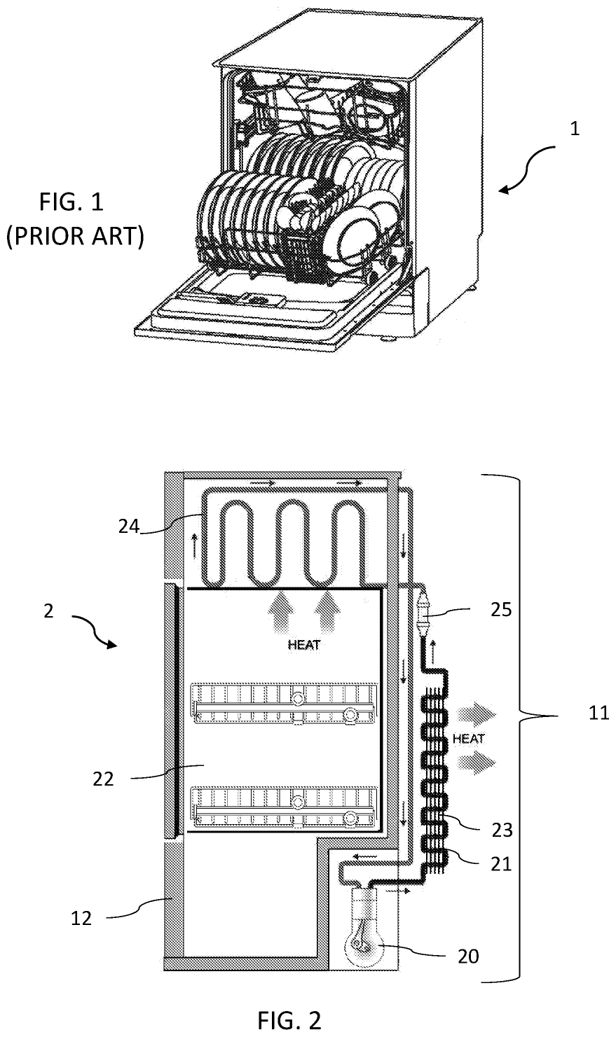

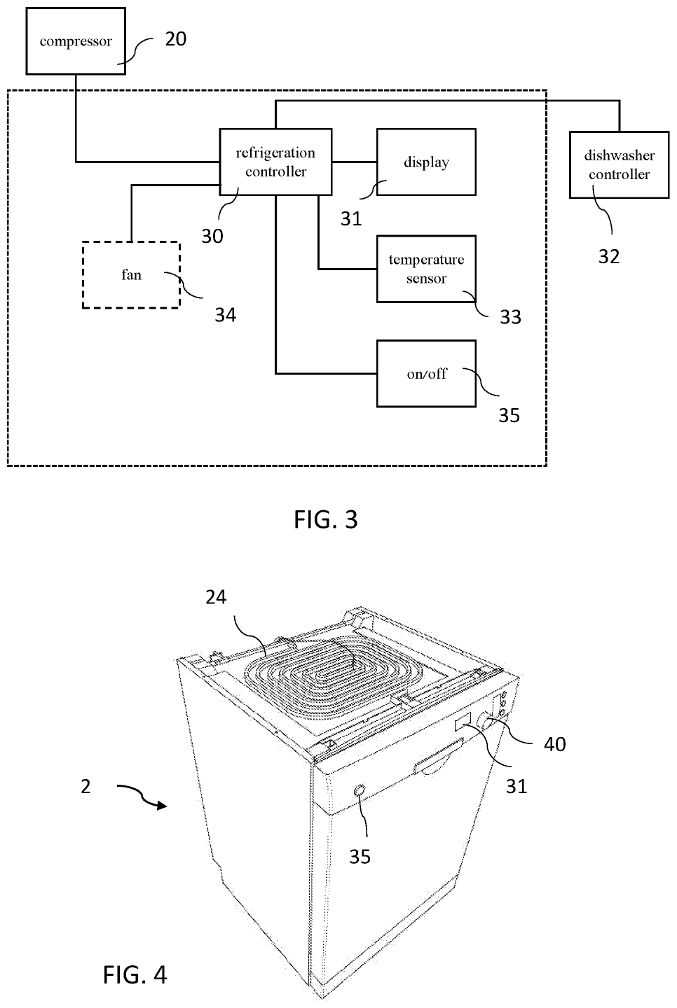

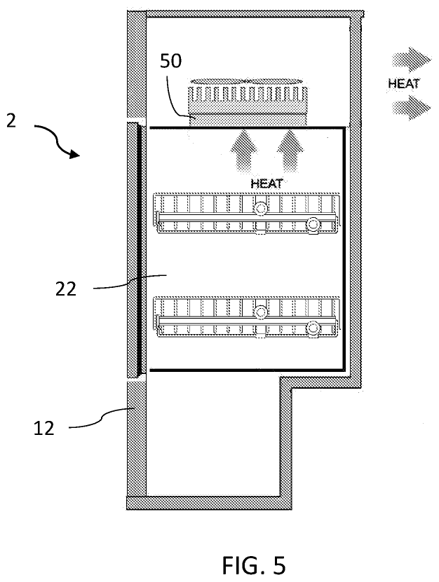

A typical prior art dishwasher 1 is depicted in FIG. 1. An embodiment of a refrigerating dishwasher 2 of the present invention is schematically illustrated in FIG. 2. The refrigerating dishwasher 2 comprises a non-refrigerating dishwasher 12 and a heat pump 11 attached to it. The heat pump 11 is based on a vapor-compression cycle in which circulating working fluid known as a refrigerant (Freon or other suitable fluid) enters a compressor 20 as a low pressure and low temperature vapor. The vapor is compressed and exits the compressor 20 superheated. The superheated vapor travels through an air-cooled condenser 21 which cools and removes the superheat and condenses the vapor into a liquid. The liquid refrigerant goes through an expansion valve 25 where its pressure abruptly decreases, causing flash evaporation of portion of the liquid. That results in a mixture of liquid and vapor at a lower temperature and pressure. The cold liquid-vapor mixture then travels through an evaporator coil 24 (which is thermally attached to a dishwasher tub 22) and is completely vaporized by cooling the warm air of the dishwasher tub 22. The resulting refrigerant vapor returns to the compressor 20 to complete the thermodynamic cycle.

The compressor 20 and condenser 21 are preferably located at the rear section of the refrigerating dishwasher 2. Alternatively, the compressor 20 and condenser 21 may be located at the bottom or side of the refrigerating dishwasher 2. The evaporator coil 24 is preferably located at the top section of the refrigerating dishwater 2 and is thermally attached to the top of the dishwasher tub 22. Alternatively, the evaporator coil 24 may be positioned at the side or bottom section of the refrigerating dishwater 2 and thermally attached to the side or the bottom of the dishwasher tub 22 respectively.

In another embodiment of the present invention the evaporator coil 24 may be positioned inside or outside the dishwasher tub 22 and the heat from the dishwasher tub 22 is then removed by convection (forced or unforced) of the hot air and/or vapor from the dishwasher tub 22 over the evaporator coil 24, or by forcing cold air into the dishwasher tub 22.

In some embodiments of the present invention, the refrigerating dishwasher 2 may comprise a refrigeration controller 30 which is connected to and controls the compressor 20 and the refrigeration cycle/s, and thus the temperature inside the dishwasher tub 22. The refrigeration controller 30 is also connected to a temperature sensor 33 that measures the temperature inside the dishwasher tub 22 and to an on/off switch 35 that turns the refrigeration controller 30 on and off. The refrigeration controller 30 is further connected to a display 31 that displays the temperature inside the dishwasher tub 22 and status of the refrigeration cycle (active/not active). The refrigeration controller 30 might be connected to a fan 34 that cools radiator fins 23 of the condenser 21. The refrigeration controller 30 might be a programmable controller and it may be further connected and controlled by a dishwasher controller 32 via a wired or wireless link.

The refrigeration controller 30 may be programmed to run various cycles of refrigeration, each cycle could be run for a predetermined time and at a predetermined temperature. The refrigeration cycle/s may be followed by a defrosting cycle to melt the ice created inside the dishwasher tub 22.

The refrigeration and/or defrosting cycles of the refrigerating dishwasher 2 could be initiated manually by pressing the on/off switch 35 or they could be initiated automatically by the preprogrammed refrigeration controller 30 or by the dishwasher controller 32.

In some other embodiments of the present invention, the refrigerating dishwasher 2 may comprise a thermostat 40 instead of the refrigeration controller 30. The thermostat 40 is connected to the compressor 20 and turns it on and off according to the temperature inside the dishwasher tub 22, thus controlling the refrigeration cycle/s and temperature inside the dishwasher tub 22.

According to yet another embodiment of the present invention, the refrigerating dishwasher 2 may comprise a thermoelectric cooler (Peltier cooler) 50 that removes heat from the dishwasher tub 22.

In another aspect, the present invention comprises a method of slowing down a decomposition of food remnants (remaining on the dishes located inside the dishwasher tub), slowing down bacterial growth and hindering development of an unpleasant odor inside a dishwasher tub by cooling the dishwasher tub to a below room temperature. The cooling is done by a heat pump that transfers heat from the dishwasher tub to an external environment. The cooling could be comprised of refrigeration and defrosting cycles (to melt ice created inside the dishwasher tub during the cooling cycle).

The present invention also improves the environment by saving energy and by reducing water pollution. The non-refrigerating dishwasher is run more often than a refrigerating one due to a need to get rid of the odor created by food leftovers adhered to the dishes. This creates an unnecessary energy, detergent and water spending.

While this disclosure has been described as having a preferred design, the present embodiments can be further modified within the scope of this disclosure. This application is therefore intended to cover any variations, uses, or adaptations of the embodiments using their general principles. Further, this application is intended to cover such departures from the present disclosure as come within known or customary practice in the art to which this disclosure pertains and which fall within the limits of the appended claims.

1-15. (canceled)

16. A dishwasher, comprising:
a dishwasher tub;
a heat pump attached to the dishwasher;
wherein the heat pump is designed to transfer heat from the dishwasher tub to an external environment so that the dishwasher tub is cooled to below room temperature in order to slow down bacterial growth and hinder development of unpleasant odors inside the dishwasher tub.

17. The dishwasher according to claim 16, wherein the heat pump comprises:
a thermoelectric cooler;
wherein the thermoelectric cooler is thermally attached to the dishwasher tub.

18. The dishwasher according to claim 16, wherein the heat pump comprises:
a compressor connected through a condenser to an expansion valve and to an evaporator;
wherein the evaporator is located outside the dishwasher tub.

19. The dishwasher according to claim 16, wherein the heat pump comprises:
a compressor connected through a condenser to an expansion valve and to an evaporator;
wherein the evaporator is thermally attached to the dishwasher tub.

20. The dishwasher according to claim 16, wherein the heat pump comprises:
a compressor connected through a condenser to an expansion valve and to an evaporator;
wherein the evaporator is thermally attached to the top of the dishwasher tub.

21. The dishwasher according to claim 19, further comprising a thermostat configured to control the compressor.

22. The dishwasher according to claim 19, further comprising a refrigeration controller configured to control the compressor.

23. A method of slowing down bacterial growth and hindering development of unpleasant odors inside a dishwasher, comprising the steps of:
cooling a dishwasher tub of the dishwasher to below room temperature.

24. The method according to claim 23, wherein the cooling step includes:
providing a heat pump attached to the dishwasher;
wherein the heat pump is designed to transfer heat from the dishwasher tub to an external environment.

25. The method according to claim 24, wherein the heat pump comprises a thermoelectric cooler.

26. The method according to claim 24, wherein the heat pump is based on a vapor-compression cycle.

27. The method according to claim 23, wherein the cooling step includes refrigeration and defrosting cycles.
